(19) United States
(12) Patent Application Publication
(10) Pub. No.: US 2010/0107861 A1
(43) Pub. Date: May 6, 2010

(54) Ballistic Seat Cover

(76) Inventor: Paul Carter, Fayetteville, NC (US)

Correspondence Address: NOVAK DRUCE + QUIGG LLP, 1300 EYE STREET NW, SUITE 1000 WEST TOWER, WASHINGTON, DC, 20005, US

(21) Appl. No.: 12/529,786

(22) PCT Filed: Mar. 4, 2008
(86) PCT No.: PCT/US2008/002847

§ 371 Date: Jan. 7, 2010

Related U.S. Application Data
(60) Provisional application No. 60/892,873, filed on Mar. 4, 2007.

(51) Int. Cl. F41H 5/04; F41H 5/06; B60R 7/00; B23P 11/00

(52) U.S. Cl. 89/36.02; 297/219.1; 29/428; 89/904; 89/914; 89/930

(57) ABSTRACT

A ballistic seat-back cover is provided and includes a pliable outer shell or housing that encompasses a inner ballistic cores which are housed or contained within an inner shell or housing. Secured to and included with exterior portions of the ballistic seat-back cover are a series of grommets that facilitate securing the ballistic seat-back cover and attaching external devices and items to a portion of the seat-back cover. Secured and incorporated into the outer cover on one surface is a plurality of webbing or strapping materials configured and spaced for efficient utilization in attaching MOLLE style items. In some embodiments, the interior ballistic cores comprise high performance fibers such as an aramid fiber, high molecular weight polyethylene, a combination of these, or other high performance fiber types.

### FIELD OF INVENTION

The present technology relates to anti-ballistic systems, and more particularly to a seat-back anti-ballistic cover that is of a relatively lightweight construction that provides supplemental ballistic protection, and with a segment utilized for placement, securing, transport, and attachment of items, equipment, and ballistic materials such as those used by military and law enforcement personnel.

### BACKGROUND OF THE INVENTION

The modern battlefield is more dangerous and violent than ever before. The nature of asymmetric warfare has moved a portion of the battlefield into an urban, indigenous setting frequently occurring in transportation sector actions. The opponent's unconventional weapon of choice (I.E.D. or Improvised Explosive Device), and small arms fire whether in solitary action or vehicle borne, causes wounds to body areas with inadequate ballistic protection and frequently renders vehicles inoperable. The utilization of vehicles in mounted patrols and transportation of personnel, material, supplies, and equipment provides a tempting target for these asymmetric warfare actions. The vehicle-borne soldiers and policemen frequently have inadequate space or means of arraying for rapid use the items, equipment, and devices employed in their duties. Often the vehicles utilized have inadequate ballistic protection and confined spaces making defensive or offensive actions difficult for the occupants.

Ballistic protection systems are widely used throughout the world in military, police, personnel protection, and security applications. Much attention has been given to the individual soldier or policeman. For example, there is a wide range of heavy-duty anti-ballistic protection devices that are commonly employed on and around military vehicles. These devices may cause the addition of weight in excess of the load bearing capacity of the vehicle and cause the “center of gravity” to shift, which can decrease the performance of the vehicle. However, no feasible option for personnel protection and organization of personal equipment has yet been provided or fielded, which clearly demonstrates an unfulfilled need.

### SUMMARY OF THE INVENTION

Therefore, there has been and continues to be a need for a versatile anti-ballistic vehicle borne-protection device such an anti-ballistic vehicle seat-back cover. Additionally, there is a need for a supplemental feature of this device that enables the vehicle occupants to organize and arrange the items and equipment necessary for effective operations and successful completion of a mission while in the confined space of the vehicle.

The present technology relates to a vehicle seat-back cover containing a segment of pliable protective ballistic materials constructed from modern high-performance fibers and a pliable outer panel or technology segment provided with a series of webbing strips positioned to allow the integration and attachment of readily available personal MOLLE items and ALICE clips for transport or efficient utilization of the panel by vehicle occupants. The panel outer perimeter contains a plurality of straps and fasteners for positioning and securing additional devices externally attached to the panel. This allows the attachment of items inside vehicles, structures, and to be “free-hanging” (e.g., embodiments of the technology have attachment points to the vehicle, but is not afixed internal component of the vehicle in various locations. Other objects and advantages of the present technology will become apparent from a study of the following description and the accompanying drawings, which are merely illustrative of such technology.

### DESCRIPTION OF THE INVENTION

The present technology is configured as a vehicle seat-back cover (a fitted cover that slides over the existing metal seat back or replaces a cushion back) providing rear supplemental ballistic protection for the seat occupant and efficient placement and arrangement of occupant items and equipment for a rear-seated occupant. In some embodiments, the technology is applied by slipping over the existing vehicle seat-back to cover the entire seat-back, reaching the portion of the sitting area of the seat and is secured to the seat with a variety of user selected attachment mechanisms and materials, e.g., to capitalize on otherwise unused vertical space for the purpose of personalized equipment placement.

In some embodiments, the portion of the technology that functions as a seat back may contain a forward-placed contoured cushion, e.g., foam piece for occupant comfort, and a ballistic protection panel constructed of a rigid or semi-rigid ballistic material. The ballistic material is contained within the outer cover, or in an inner pocket constructed of a pliable, abrasion, moisture, and flame resistant quick drying material, e.g. material that is e.g., ventilated, mildew and POL resistant.

The portion of the technology that functions as the vehicle rear occupant utility side for item and equipment organization and arrangement panel contains a plurality of webbing or other such materials placed for attachment of standard military issued or compliant MOLLE-compatible pouches and items. In some embodiments, the webbing is placed in a vertical or in a horizontal array, or in combination of directions. The outer perimeter of the panel incorporates a plurality of grommets, e.g., for user attachment of D-Rings and attachment devices. The configuration and placement of these attachment devices will accommodate and allow the utilization of a wide variety of user supplied attachment mechanisms and devices. In some embodiments, this utility side of the device is attached on three sides to the seat back portion, e.g., to accommodate the device to the vehicle frame.

Embodiments of he technology slip over the top of a vehicle seat-back, cover the seat-back to the seat portion and provide a vertical surface for placement and attachment of MOLLE and compatible items, and ready access and utilization of these items, e.g., by a rear seat occupant.

### BRIEF DESCRIPTION OF THE DRAWINGS

FIG. 1 is an oblique perspective view of the right rear side of some embodiments of the present technology.

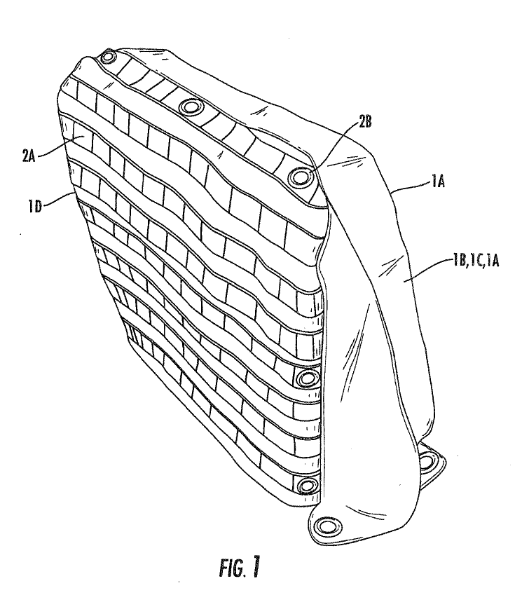

FIG. 2 is a perspective view of the front side of some embodiments of the present technology.

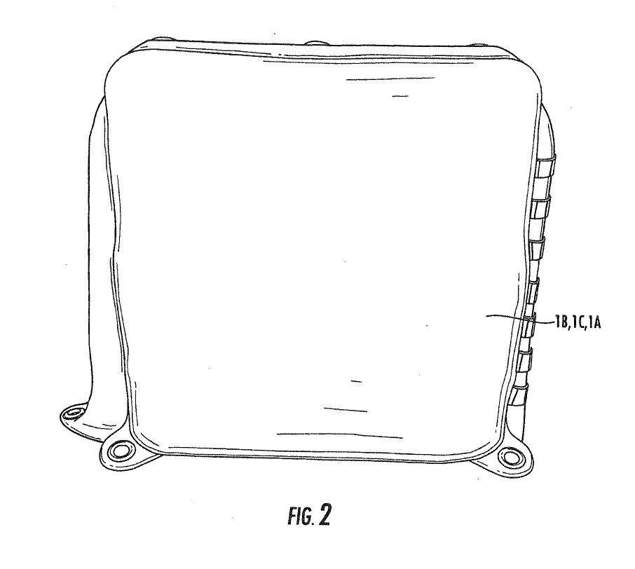

FIG. 3 is a perspective view of the rear side of some embodiments of the present technology.

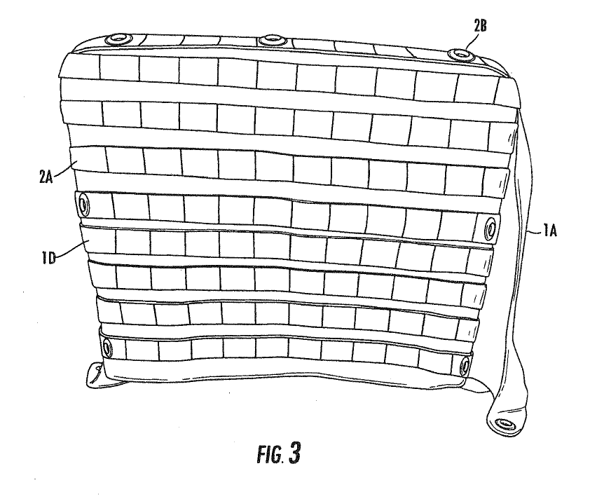

### DETAILED DESCRIPTION

With further reference to the drawings, the ballistic seat-back cover is shown herein. Generally, some embodiments of the seat cover include: an outer shell, housing, or carrier that holds or contains a foam or padding material for occupant comfort, a pliable ballistic material with material carrier, a rear panel is comprised of a pliable material containing a plurality of straps and webbing and a plurality of grommets, fasteners, and attachment devices at or near the panel outer perimeter.

The technology is comprised of these material items:

Outer cover or carrier:
1A Outer cover
1B Padding
1C Ballistic Material
1D Utility Panel
2A Webbing material
2B Grommet

What is claimed is:

1. A seat-back cover, comprising:
an outer pliable housing having an outer surface and an inner surface, and which forms a generally closed interior area, the outer housing being relatively thin compared to the length and width of the outer housing;
an inner housing disposed in the interior area of the outer housing and generally surrounded by the outer housing;
a ballistic core contained within the inner housing and comprising high performance fibers such as high molecular weight polyethylene, aramid fibers, or a combination of these and other high performance fibers;
the outer housing including a perimeter and including a series of grommets, eyelets, loops, snaps, or other attachments disposed around the perimeter of the outer housing;

2. The ballistic vehicle seat-back cover of claim 1 wherein the outer housing is constructed of material taken from the groups including fabric, vinyl, leather, and/or pliable synthetic materials.

3. The ballistic seat-back cover of claim 1 wherein the outer housing includes two sides with one side separated into at least two sections and wherein there is provided a plurality of access openings that permits access to the inner housing and wherein the access openings at least partially delineates the two sections.

4. The ballistic seat-back cover of claim 1 wherein the outer housing includes two opposed sides, and wherein straps or webbing are secured to the surface of one side. In some embodiments, the webbing strips, e.g. 1″ wide, are placed apart, e.g., 1″, in such configuration as to be integratable with current MOLLE type devices, and attached with BTARTACS or other acceptable textile methods.

5. The ballistic seat-back cover of claim 1 wherein the seat-back cover is secured to a seat or a seat frame inside a vehicle; and adjustable to a seat that will receive such a device.

6. The ballistic seat-back cover of claim 1 wherein the ballistic core is a high performance fiber such as an aramid fiber, ultra-high molecular weight polyethylene, or a combination of these, and other high performance fiber types.

7. A method of manufacturing ballistic vehicle seat-back covers, comprising:
forming a pliable outer housing having an outer surface and an inner surface and forming a plurality of generally closed interior areas;
inserting inner housings into the interior area of the outer housing where the inner housings forms enclosures and when inserted into the outer housing, the inner housings are surrounded and generally enclosed by the outer housing;
forming panels of high performance fibers such as aramid fibers, ultra-high molecular weight polyethylene, or a combination of these, and other high performance fibers;
inserting ballistic cores into the inner housings such that the ballistic cores are surrounded and enclosed by both the inner housings and the outer housing;
positioning and attaching webbing to one side of the outer housing;
positioning and attaching grommets at or near the outer perimeter of the outer housing;
forming and positioning grommets and attachment devices for securing the outer housing to a vehicle seat;
